(19) United States
(12) Patent Application Publication
(10) Pub. No.: US 2023/0312884 A1
(43) Pub. Date: Oct. 5, 2023

(54) High Clarity Polysaccharide Ester Polymer Composition Containing Odor Control Agent

(71) Applicant: Celanese International Corporation, Irving, TX (US)

(72) Inventors: Xiaowei Zhang, Union, KY (US); Chongwen Huang, Florence, KY (US); Christopher McGrady, Walton, KY (US)

(21) Appl. No.: 18/119,612

(22) Filed: Mar. 9, 2023

Related U.S. Application Data
(60) Provisional application No. 63/318,160, filed on Mar. 9, 2022.

(51) Int. Cl. C08L 1/12; C08K 5/00; C08K 3/105; C08J 5/18

(52) U.S. Cl. CPC C08L 1/12; C08J 5/18; C08K 3/105; C08K 5/0016; C08J 2301/12; C08L 2201/10; C08L 2203/16

(57) ABSTRACT

A polymer composition is disclosed formed from a polysaccharide ester polymer, a plasticizer, and at least one odor control agent. The odor control agent is designed to control odors and/or acid emissions during melt processing of the composition without significantly interfering with the optical characteristics of the composition.

### RELATED APPLICATIONS

The present application is based upon and claims priority to U.S. Provisional Pat. Application Serial No. 63/318,160, having a filing date of Mar. 9, 2022, which is incorporated herein by reference.

### BACKGROUND

Polysaccharide ester polymers, such as cellulose ester polymers, have been proposed in the past as a replacement to some petroleum-based polymers or plastics. Cellulose esters, for instance, are generally considered environmentally-friendly polymers because they are recyclable, degradable and derived from renewable resources, such as wood pulp. Problems have been experienced, however, in melt processing cellulose ester polymers, such as cellulose acetate polymers. The polymer materials are relatively stiff and have relatively poor elongation properties. In addition, the melting temperature of cellulose ester polymers is very close to the degradation temperature, further creating obstacles to melt processing the polymers successfully. Further, cellulose ester polymers can create and release chemical components, such as carboxylic acids, during processing and after the polymer articles are formed. These chemical components can not only cause corrosion in the polymer processing equipment but can also create unwanted and undesirable odors.

In the past, in order to reduce odors, the cellulose ester polymers have been combined with inorganic deodorants, such as clay particles, metal phosphates, metal sulfates, charcoal, and the like. The above particles, however, can adversely impact various properties of polymer articles formed from the cellulose ester polymer compositions. For example, the above inorganic deodorants can significantly and adversely impact the optical properties of the polymer composition. Polymer articles formed from the polymer composition, for instance, can be discolored and can lack transparent or translucent characteristics.

In view of the above, a need currently exists for biodegradable polymer compositions that have similar properties to petroleum-based polymers and can be melt processed for forming various three-dimensional articles. A need also exists for a polysaccharide ester polymer composition that produces reduced amounts of odors while still having excellent optical and/or clarity characteristics.

### SUMMARY

In general, the present disclosure is directed to a polymer composition containing a polysaccharide ester polymer, such as a cellulose ester polymer, in combination with at least one odor control agent. The odor control agent, for instance, is present in the polymer composition in relatively minor amounts and is capable of inhibiting the production or release of odors from the composition during melt processing and during use of molded articles made from the polymer composition. The odor control agent is selected so as to control odors without significantly interfering with the optical properties of the polymer composition. In this regard, molded articles made from the composition can display relatively low haze and/or can display relatively high light transmission properties.

In order to form polymer articles, the cellulose ester polymer and odor control agent are combined with a plasticizer in order to form a gel-like composition. The cellulose ester polymer and plasticizer mixture can then be extruded into various shapes, including fibers, films, and other three dimensional articles. The polymer composition, for example, is well suited for producing all different types of polymer articles, including packaging, beverage holders, plastic containers, drinking straws, hot beverage pods, automotive parts, consumer appliance parts, and the like. In one aspect, the polymer composition can first be formed into a film which is then thermoformed into a final product.

In one embodiment, the present disclosure is directed to a polymer composition well suited for producing molded articles. The polymer composition contains a polysaccharide ester polymer, such as a cellulose ester polymer, combined with a plasticizer and an odor control agent. The odor control agent, for example, can comprise a mineral filler in the form of particles dispersed throughout the polymer composition. The odor control agent can be present in the composition in an amount of from about 0.05% by weight to about 3% by weight. In one aspect, the odor control agent can be present in the polymer composition in an amount sufficient to reduce free carboxylic acid content by greater than about 10%, such as greater than about 20%, such as greater than about 30%. In addition, the polymer composition can display excellent optical properties when molded into articles. For example, the composition can display a light transmission of greater than about 10%, such as greater than about 20%, such as greater than about 50%, such as greater than about 70% when measured according to ASTM Test D1003. Alternatively, articles molded from the polymer composition can display a haze of less than about 55%, such as less than about 40%, such as less than about 30%, such as less than about 20%, such as less than about 15%, such as less than about 10%, when measured according to ASTM Test D1003. Haze, for instance, can be measured at a thickness of 3 or 4 mm. Light transmission, on the other hand, can be measured at a wavelength of from 380 nm to 780 nm and also at a thickness of 3 or 4 mm.

In one embodiment, the odor control agent can comprise a magnesium compound. For example, the odor control agent can comprise a magnesium oxide. Alternatively, the odor control agent can be a zinc compound or an aluminum compound. In one aspect, the composition can be formulated so as to be free of other mineral fillers, such as calcium carbonate.

In one aspect, the aluminum compound can comprise an aluminum sodium carbonate compound, or an aluminum silicate.

In one aspect, the magnesium compound can be a magnesium hydroxide, a hydrotalcite, or mixtures thereof. The hydrotalcite may have the following chemical formula:

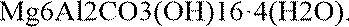

The odor control agent, such as the hydrotalcite, may optionally be coated. Example coatings include fatty acids (e.g., higher fatty acids), anionic surfactants, phosphates, coupling agents, and esters of polyhydric alcohols and fatty acids. Specific examples in some embodiments include higher fatty acids having 10 or more carbon atoms such as stearic acid, erucic acid, palmitic acid, lauric acid and behenic acid; alkali metal salts of the higher fatty acids; sulfuric ester salts of higher alcohols such as stearyl alcohol and oleyl alcohol; anionic surfactants such as sulfuric ester salts of polyethylene glycol ethers, amide-bonded sulfuric ester salts, ester-bonded sulfuric ester salts, ester-bonded sulfonates, amide-bonded sulfonates, ether-bonded sulfonates, ether-bonded alkyl aryl sulfonates, ester-bonded alkyl aryl sulfonates and amide-bonded alkyl aryl sulfonates; phosphates such as acid and alkali metal salts and amine salts of orthophosphoric acid and mono- or di-esters such as oleyl alcohol and stearyl alcohol or mixtures thereof; silane coupling agents such as vinylethoxysilane, vinyl-tris(2-methoxy-ethoxy)silane, γ-methacryloxypropyl trimethoxysilane, γ-aminopropyl trimethoxysilane, β-(3,4-epoxycyclohexyl)ethyl trimethoxysilane, γ-glycidoxypropyl trimethoxysilane and γ-mercaptopropyl trimethoxysilane; titanate-based coupling agents such as isopropyltriisostearoyl titanate, isopropyltris(dioctylpyrophosphate)titanate, isopropyltri(N-aminoethyl-aminoethyl)titanate and isopropyltridecylbenzenesulfonyl titanate; aluminum-based coupling agents such as acetoalkoxyaluminium diisopropylate; and esters of polyhydric alcohols and fatty acids such as glycerin monostearate and glycerin monooleate.

The polymer composition can contain the cellulose ester polymer generally in an amount from about 15% by weight to about 85% by weight, such as from about 55% by weight to about 85% by weight. The plasticizer can be present in the polymer composition in an amount from about 10% to about 40% by weight. In general, any suitable cellulose ester polymer can be contained in the polymer composition. The cellulose ester polymer can have a degree of substitution of from about 1.3 to about 2.9. The plasticizer, on the other hand, can comprise polyethylene glycol, monoacetin, diacetin, triacetin, triethyl citrate, acetyl triethyl citrate, or mixtures thereof.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a drinking straw that may be made in accordance with the present disclosure;

FIG. 2 is a cross-sectional view of a beverage holder that may be made in accordance with the present disclosure;

FIG. 3 is a side view of one embodiment of a beverage pod that can be made in accordance with the present disclosure;

FIG. 4 is a cross-sectional view of a drinking bottle that may be made in accordance with the present disclosure;

FIG. 5 is a perspective view of an automotive interior illustrating various articles that may be made in accordance with the present disclosure;

FIG. 6 is a perspective view of cutlery made in accordance with the present disclosure;

FIG. 7 is a perspective view of a lid made in accordance with the present disclosure;

FIG. 8 is a perspective view of a container made in accordance with the present disclosure;

FIG. 9 illustrates one embodiment of a medical apparatus comprising a composition prepared according to the present disclosure;

FIG. 10 illustrates another embodiment of a medical apparatus comprising a composition prepared according to the present disclosure;

FIG. 11 illustrates still another embodiment of a medical apparatus comprising a composition prepared according to the present disclosure; and

FIG. 12 illustrates another embodiment of a medical apparatus comprising a composition prepared according to the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition containing a biodegradable polysaccharide ester polymer, such as a cellulose ester polymer. Cellulose ester polymers are not only biodegradable but are also sustainable and can be produced from renewable resources. Consequently, such polymers offer various advantages and benefits over many fossil-based polymers. Cellulose ester polymers, however, have a tendency to generate steam and acidic odors during compounding and melt processing. Consequently, the present disclosure is directed to incorporating one or more odor control agents into the polysaccharide ester polymer composition for controlling odors and emissions. In one aspect, one or more odor control agents are particularly selected and are loaded into the composition at amounts such that odors are reduced, without compromising other properties of the polymer composition, particularly the optical properties of the polymer composition. Thus, in one embodiment, the present disclosure is directed to a polysaccharide ester polymer composition containing one or more odor control agents while possessing excellent haze properties and/or clarity characteristics.

Polymer compositions formulated in accordance with the present disclosure can also have dramatically improved stiffness and elongation properties in addition to low carboxylic acid emission characteristics. Further, the polymer composition of the present disclosure can be formulated to be biodegradable and thus environmentally friendly. The polymer composition can be used to form all different types of products using any suitable molding technique, such as extrusion, thermoforming, injection molding, and the like.

As described above, the polymer composition contains a polysaccharide ester polymer in combination with one or more odor control agents. In addition, a plasticizer and one or more other biodegradable polymers can be incorporated into the composition in order to vary and change the physical properties of articles formed from the composition. Odor control agents that are incorporated into the composition generally comprise mineral fillers that were found to reduce odors while maintaining the optical characteristics of articles formed from the composition. In this regard, the odor control agent may comprise inorganic salt particles, organic salt particles, or mixtures thereof. The odor control agent, for instance, may comprise oxide salts or hydroxide salts, particularly metal oxides or metal hydroxides. In one particular aspect, the odor control agent comprises a magnesium compound or salt. Alternatively, the odor control agent can be a zinc compound, an aluminum compound, or mixtures of the above. In one aspect, one or more odor control agents are added to the polymer composition in an amount sufficient to reduce free carboxylic acid content by at least about 20%, such as by at least about 25%, such as by at least about 30%, such as by at least about 35%, such as by at least about 40%, such as by at least about 45%, such as by at least about 50%, such as by at least about 55%, such as by at least about 60%, such as by at least about 65%, such as by at least about 70%, such as by at least about 75%, such as by at least about 80%. For example, in one embodiment, one or more odor control agents can be added to the polymer composition in order to reduce acetic acid emission by any of the above amounts. Free carboxylic acid content can be measured using gas chromatography after extraction, such as by measuring acetic acid content after extraction.

In addition to having low carboxylic acid emission, polymer compositions made according to the present disclosure can also produce articles with very low haze and high clarity.

For example, polymer articles made according to the present disclosure can be measured for haze according to ASTM Test D1003 (2013). Haze can be measured using any acceptable instrument according to the ASTM Test including, for instance, a BYK Gardner Haze-Gard 4725 instrument. Haze can be measured on a test plaque, on a film made according to the present disclosure, or on the final thermoformed article. The test plaque can have any suitable thickness, such as 1 mm, 2 mm, 3 mm, or 4 mm. When any of the above samples are tested, the haze of the sample or article can generally be less than about 55%, such as less than about 40%, such as less than about 30%, such as less than about 20%, such as less than about 15%, such as less than about 10%, such as less than about 8%, such as less than about 5%, such as less than about 3%, such as less than about 2%. In one aspect, the haze can be less than 1%, such as less than about 0.8%, such as less than about 0.5%, such as less than about 0.4%, such as less than about 0.3%, such as less than about 0.2%.

In addition to low haze, polymer films and articles made according to the present disclosure can also have high transmission rates (transparency), whether the article is translucent (e.g. is a shade of color containing one or more coloring agents) or transparent. For example, when measured for transmission properties at a wavelength of from about 380 nm to about 780 nm, the polymer film or article can display a transmission of greater than about 10%, such as greater than about 20%, such as greater than about 30%, such as greater than about 40%, such as greater than about 50%, such as greater than about 60%, such as greater than about 70%, such as greater than about 75%, such as greater than about 80%, such as greater than about 85%, such as greater than about 90%, such as greater than about 95%. Light transmission can be measured at a thickness of 3 mm or 4 mm.

Another way to measure the optical characteristics of the polymer composition is to conduct a gel analysis test. The gel analysis test can be performed on a film made from the polymer composition. The gel analysis test can be conducted by an FSA-100 film surface analyzer commercially available from OCS GmbH of Witten, Germany. The film surface analyzer can include a 4096 pixel CMOS digital camera with a complementary metal oxide semiconductor sensor. The film surface analyzer can have a 50 micron nominal resolution and can include an LED lighting system that enables optimal defect detection in transparent, opaque and colored polymer films. Films can be tested according to the present disclosure at any suitable thickness, such as at a thickness of 25.4 microns. The FSA LID setting is set at 40. The parcel length is set at 102.4 mm and the parcel width is set at 80.00 mm. The parcel area is 8192.00 mm². 367 parcels are inspected and the inspection area is 3.006 m². The inspected length is 37.581 m. The levels are set at 40%-10%-. The other settings include gray value at 169, mean filter size at 50 (50), film speed at 7.01 m/min, exposure time at 0.013 ms, transparency/noise set at 98.88%/2.83%, X resolution set at 50 microns, and Y resolution set at 50 microns. The gel analysis test measures the number of defects per area and the size of the defects.

Films and articles made according to the present disclosure, for instance, can display defects having a size of 300 microns or greater of less than about 5,000 defects/m², such as less than about 3,500 defects/m², such as less than about 2,000 defects/m². Films and articles made according to the present disclosure can display defects having a size of 200 microns or greater in an amount less than about 25,000 defects/m², such as in an amount less than about 20,000 defects/m², such as in an amount of less than about 15,000 defects/m². Films and articles made according to the present disclosure can display defects having a size of 100 microns or greater in an amount less than about 70,000 defects/m², such as in an amount less than about 60,000 defects/m², such as in an amount of less than about 50,000 defects/m².

Films and articles made according to the present disclosure can have a total defect area of less than about 9,000 mm², such as less than about 8,000 mm², such as less than about 7,000 mm², such as less than about 6,000 mm², such as less than about 5,000 mm², such as less than about 4,000 mm², such as less than about 3,000 mm², such as less than about 2,000 mm².

In general, any suitable polysaccharide ester polymer can be incorporated into the polymer composition. In one aspect, a cellulose ester polymer or cellulose acetate polymer is used.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

The biodegradation of the cellulose ester polymer can depend upon various factors including the degree of substitution. The degree of substitution of cellulose ester can be measured, for example, using ASTM Test 871-96 (2010). The cellulose acetate polymer incorporated into the polymer composition can generally have a degree of substitution of greater than about 2.0, such as greater than about 2.1, such as greater than about 2.2, such as greater than about 2.3. The degree of substitution is generally less than about 3.0, such as less than about 2.8, such as less than about 2.6, such as less than about 2.4, such as less than about 2.35, such as less than about 2.3, such as less than about 2.25. In one aspect, for instance, the cellulose acetate polymer has a degree of substitution of from about 2.1 to about 2.8, including all increments of 0.1 therebetween.

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$\begin{matrix}I V = \left(\frac{k}{c}\right) \left(\text{antilog} \left(\left(log {n}_{r e t}\right) / k\right) - 1\right) \\ \text{where} {n}_{r e t} = \left(\frac{{t}_{1}}{{t}_{2}}\right) ,\end{matrix} \qquad \text{Equation 1}$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose acetate is generally present in the polymer composition in an amount greater than about 15% by weight, such as in an amount greater than about 25% by weight, such as in an amount greater than about 35% by weight, such as in an amount greater than about 45% by weight, such as in an amount greater than about 55% by weight. The cellulose acetate is generally present in the polymer composition in an amount less than about 85% by weight, such as in an amount less than about 80% by weight, such as in an amount less than about 75% by weight, such as in an amount less than about 70% by weight, such as in an amount less than about 65% by weight.

A cellulose acetate as described above can be combined with one or more plasticizers. Plasticizers particularly well suited for use in the polymer composition include triacetin, monoacetin, diacetin, and mixtures thereof. In one aspect, the plasticizer incorporated into the polymer composition is a polyalkylene glycol, such as a polyethylene glycol. Other suitable plasticizers include tris(clorisopropyl) phosphate, tris(2-chloro-1-methylethyl) phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

The plasticizer can also be bio-based. For example, using a bio-based plasticizer can render the polymer composition well suited for contact with food items. Bio-based plasticizers particularly well suited for use in the composition of the present disclosure include an alkyl ketal ester, a non-petroleum hydrocarbon ester, a bio-based polymer or oligomer, such as polycaprolactone, having a number average molecular weight of 1000 or less, or mixtures thereof.

In one aspect, the plasticizer is phthalate-free. In fact, the polymer composition can be formulated to be phthalate-free. For instance, phthalates can be present in the polymer composition in an amount of about 0.5% or less, such as in an amount of about 0.1% or less.

In general, one or more plasticizers can be present in the polymer composition in an amount from about 8% to about 40% by weight, such as in an amount from about 12% to about 35% by weight. In one aspect, one or more plasticizers can be present in the polymer composition in an amount of about 19% or less, such as in an amount of about 17% or less, such as in an amount of about 15% or less, such as in an amount of about 13% or less, such as in an amount of about 10% or less. One or more plasticizers are generally present in an amount from about 5% or greater, such as in an amount of about 10% or greater, such as in an amount of about 12% or greater, such as in an amount of about 15% or greater, such as in an amount of about 18% or greater, such as in an amount of about 22% or greater, such as in an amount of about 25% or greater.

The cellulose acetate can be present in relation to the plasticizer such that the weight ratio between the cellulose acetate and the one or more plasticizers is from about 60:40 to about 85:15, such as from about 70:30 to about 80:20. In one embodiment, the cellulose acetate to plasticizer weight ratio is about 75:25.

In accordance with the present disclosure, the cellulose acetate and one or more plasticizers are combined with one or more odor control agents to reduce odors and/or acid emissions, such as carboxylic acid emissions. The odor control agents that can be incorporated into the composition include various mineral fillers in the form of particles that have been found to reduce odor while unexpectedly not deteriorating the optical properties of the polymer composition when formed into articles.

Odor control agents that can be used in accordance with the present disclosure include hydroxide salts, oxide salts, bicarbonate salts, mixtures thereof and the like. The odor control agent, for instance, can be a metal salt, such as a transition metal salt.

The odor control agent can comprise a zinc compound or an aluminum compound. The zinc compound can be a zinc oxide. The aluminum compound can comprise an aluminum oxide, an aluminum sodium carbonate compound, or an aluminum silicate.

In one embodiment, the odor control agent comprises one or more magnesium compounds or salts. For instance, the odor control agent can comprise magnesium oxide, magnesium hydroxide, a hydrotalcite, or combinations thereof. In one aspect, the magnesium compound can comprise the hydrotalcite.

Any suitable hydrotalcite may be used. Hydrotalcite is a nonstoichiornetric compound that, in one aspect, can be represented by a general formula: [Mg₁₋ₓ Alₓ (OH)_{z}]^{×+} [(CO3)_{x/2}·m(H2O)]^{x-} and is an inorganic material having a layered crystal structure that can include a positively charged base layer and a negatively charged intermediate layer. In the one embodiment above, x represents a number in a range greater than 0 and less than or equal to 0.5, such as 0.33. Natural hydrotalcite can be represented by Mg6Al2(OH)16CO3.4H2O. One example of a synthesized hydrotalcite is Mg45Al2(OH)13CO3.3.5H2O. The hydrotalcite can have an average particle size (d50) of less than 1 micron, such as less than about 0.6 microns and greater than about 0.1 microns.

The odor control agent, such as the hydrotalcite, may optionally be coated. Example coatings include fatty acids (e.g., higher fatty acids), anionic surfactants, phosphates, coupling agents, and esters of polyhydric alcohols and fatty acids. Specific examples in some embodiments include higher fatty acids having 10 or more carbon atoms such as stearic acid, erucic acid, palmitic acid, lauric acid and behenic acid; alkali metal salts of the higher fatty acids; sulfuric ester salts of higher alcohols such as stearyl alcohol and oleyl alcohol; anionic surfactants such as sulfuric ester salts of polyethylene glycol ethers, amide-bonded sulfuric ester salts, ester-bonded sulfuric ester salts, ester-bonded sulfonates, amide-bonded sulfonates, ether-bonded sulfonates, ether-bonded alkyl aryl sulfonates, ester-bonded alkyl aryl sulfonates and amide-bonded alkyl aryl sulfonates; phosphates such as acid and alkali metal salts and amine salts of orthophosphoric acid and mono- or di-esters such as oleyl alcohol and stearyl alcohol or mixtures thereof; silane coupling agents such as vinylethoxysilane, vinyl-tris(2-methoxy-ethoxy)silane, γ-methacryloxypropyl trimethoxysilane, γ-aminopropyl trimethoxysilane, β-(3,4-epoxycyclohexyl)ethyl trimethoxysilane, γ-glycidoxypropyl trimethoxysilane and γ-mercaptopropyl trimethoxysilane; titanate-based coupling agents such as isopropyltriisostearoyl titanate, isopropyltris(dioctylpyrophosphate)titanate, isopropyltri(N-aminoethyl-aminoethyl)titanate and isopropyltridecylbenzenesulfonyl titanate; aluminum-based coupling agents such as acetoalkoxyaluminium diisopropylate; and esters of polyhydric alcohols and fatty acids such as glycerin monostearate and glycerin monooleate.

The odor control agents can be added in the form of particles. The particles can have an average particle size as determined by light scattering of less than about 10 microns, such as less than about 8 microns, such as less than about 5 microns, such as less than about 3 microns, such as less than about 1 micron, such as less than about 0.5 microns. The particles generally have an average particle size of greater than about 10 nm, such as greater than about 50 nm, such as greater than about 70 nm, such as greater than about 100 nm, such as greater than about 200 nm.

The odor control agents can have a relatively high surface area. For example, the particles can have a BET surface area of greater than about 50 m²/g, such as greater than about 70 m²/g, such as greater than about 100 m²/g, such as greater than about 110 m²/g, and generally less than about 800 m²/g, such as less than about 500 m²/g.

Of particular advantage, it was discovered that the odor control agents of the present disclosure can be very effective at controlling odors and acid emissions at very low concentrations. For instance, one or more odor control agents can be present in the polymer composition generally in an amount less than about 3% by weight, such as in an amount less than about 2.5% by weight, such as in an amount less than about 2% by weight, such as in an amount less than about 1.5% by weight, such as in an amount less than about 1% by weight, such as in an amount less than about 0.8% by weight, such as in an amount less than about 0.6% by weight, such as in an amount less than about 0.4% by weight, such as in an amount less than about 0.2% by weight. One or more odor control agents are generally present in the polymer composition in an amount greater than about 0.01% by weight, such as in an amount greater than about 0.05% by weight, such as in an amount greater than about 0.1% by weight.

The cellulose acetate, the one or more plasticizers and the one or more odor control agents can also be combined with one or more bio-based polymers that are different than the cellulose acetate and the one or more plasticizers. As used herein, a “bio-based” polymer or plasticizer refers to a polymer, oligomer, or compound produced from at least partially renewable biomass sources, such as produced from plant matter or food waste. For example, a bio-based polymer can be a polymer produced from greater than 30% renewable resources, such as greater than about 40% renewable resources, such as greater than about 50% renewable resources, such as greater than about 60% renewable resources, such as greater than about 70% renewable resources, such as greater than about 80% renewable resources, such as greater than about 90% renewable resources. Bio-based polymers are to be distinguished from polymers derived from fossil resources such as petroleum. Bio-based polymers can be bio-derived meaning that the polymer originates from a biological source or produced via a biological reaction, such as through fermentation or other microorganism process. Although a cellulose ester polymer can be considered a bio-based polymer, the term herein refers to other bio-based substances that can be combined with cellulose ester polymers.

In one aspect, the bio-based polymer can be a polyester polymer, such as an aliphatic polyester. Particular bio-based polymers that may be incorporated into the polymer composition include polyhydroxyalkanoates, polylactic acid, polycaprolactone, or mixtures thereof.

In one aspect, the physical properties of the cellulose acetate can be particularly improved if at least one bio-based polymer is combined with the cellulose acetate that has a low glass transition temperature and/or is amorphous or is semi-crystalline. For example, a bio-based polymer can be selected for combining with the cellulose acetate that is completely or substantially amorphous or has a low degree of crystallinity. The degree of crystallinity is the fraction of the polymer that exists in an orderly state, having a lattice structure. For example, the bio-based polymer combined with the cellulose acetate can have a crystallinity of less than about 30%, such as less than about 25%, such as less than about 20%, such as less than about 15%, such as less than about 10%, such as less than about 5%. The degree of crystallinity can be determined using X-ray and electron diffraction, differential scanning calorimetry, infrared absorption (FTIR) or Raman spectroscopy.

The at least one bio-based polymer combined with the cellulose acetate can also have a relatively low glass transition temperature. For instance, the glass transition temperature of the bio-based polymer can be less than about 40° C., such as less than about 20° C., such as less than about 10° C., such as less than about 5° C., such as less than about 0° C., such as less than about -5° C., such as less than about -10° C., such as less than about -20° C. The glass transition temperature (Tg) is generally greater than about -40° C., such as greater than about -30° C.

In comparison, the glass transition temperature of cellulose acetate is generally from 160° C. to 180° C. Differences in glass transition temperatures can lead to compatibility issues. However, to the contrary, the use of a bio-based polymer with a low glass transition temperature and/or low crystallinity has been found to not only be compatible with cellulose acetate, but also improves many physical properties of the cellulose acetate including elongation to break and toughness. The addition of the bio-based polymer as described above can also reduce the flexural modulus.

In one aspect, the at least one bio-based polymer combined with the cellulose acetate is a polyhydroxyalkanoate. The polyhydroxyalkanoate can be a homopolymer or a copolymer. Polyhydroxyalkanoates, also known as “PHAs”, are linear polyesters produced in nature by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can significantly impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about -30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4-hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-co-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

In one embodiment of the present disclosure, a cellulose acetate is combined with a PHA that has a crystallinity of about 25% or less and has a low glass transition temperature. For instance, the glass transition temperature can be less than about 10° C., such as less than about 5° C., such as less than about 0° C., such as less than about -5° C., and generally greater than about -40° C., such as greater than about -20° C. Such PHAs can dramatically reduce the stiffness properties of the cellulose acetate, thereby increasing the elongation properties and decreasing the flexural modulus properties. As used herein, the glass transition temperature can be determined by dynamic mechanical analysis in accordance with ASTM Test E1640-09.

When present, one or more PHAs can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. One or more PHAs are generally present in the polymer composition in an amount of about 30% or less, such as in an amount of about 25% or less, such as in an amount of about 20% or less, such as in an amount of about 15% or less.

In addition to one or more PHAs, the polymer composition can contain various other bio-based polymers, such as a polylactic acid or a polycaprolactone. Polylactic acid also known as “PLAs” are well suited for combining with one or more PHAs. Polylactic acid polymers are generally stiffer and more rigid than PHAs and thus can be added to the polymer composition for further refining the properties of the overall formulation.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

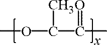

The polylactic acid typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

The polylactic acid may also have an apparent viscosity of from about 50 to about 600 Pascal seconds (Pa·s), in some embodiments from about 100 to about 500 Pa·s, and in some embodiments, from about 200 to about 400 Pa·s, as determined at a temperature of 190° C. and a shear rate of 1000 sec⁻¹. The melt flow rate of the polylactic acid (on a dry basis) may also range from about 0.1 to about 40 grams per 10 minutes, in some embodiments from about 0.5 to about 20 grams per 10 minutes, and in some embodiments, from about 5 to about 15 grams per 10 minutes, determined at a load of 2160 grams and at 190° C.

Polylactic acid can be present in the polymer composition in an amount of about 1% or greater, such as in an amount of about 3% or greater, such as in an amount of about 5% or greater, and generally in an amount of about 20% or less, such as in an amount of about 15% or less, such as in an amount of about 10% or less, such as in an amount of about 8% or less.

Another bio-based polymer that may be combined with cellulose acetate alone or in conjunction with other bio-based polymers is polycaprolactone having a molecular weight higher than a polycaprolactone plasticizer. Polycaprolactone, similar to PHAs, can be formulated to have a relatively low glass transition temperature. The glass transition temperature, for instance, can be less than about 10° C., such as less than about -5° C., such as less than about -20° C., and generally greater than about -60° C. The polymers can be produced so as to be amorphous or semi-crystalline. The crystallinity of the polymers can be less than about 50%, such as less than about 25%.

Polycaprolactones can be made having a number average molecular weight of generally greater than about 5,000, such as greater than about 8,000, and generally less than about 15,000, such as less than about 12,000.

Polycaprolactones can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. Polycaprolactones are generally present in the polymer composition in an amount of about 30% or less, such as in an amount of about 25% or less, such as in an amount of about 20% or less, such as in an amount of about 15% or less.

Other bio-based polymers that may be incorporated into the polymer composition include polybutylene succinate, polybutylene adipate terephthalate, a plasticized starch, other starch-based polymers, and the like. In addition, the bio-based polymer can be a polyolefin or polyester polymer made from renewable resources. For example, such polymers include bio-based polyethylene, bio-based polybutylene terephthalate, and the like.

The polymer composition of the present disclosure may optionally contain various other additives and ingredients. For instance, the polymer composition may contain antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

The polymer composition of the present disclosure can be formed into any suitable polymer article using any technique known in the art. For instance, polymer articles can be formed from the polymer composition through extrusion, injection molding, blow molding, and the like.

Polymer articles that may be made in accordance with the present disclosure include drinking straws, beverage holders, automotive parts, knobs, door handles, consumer appliance parts, and the like.

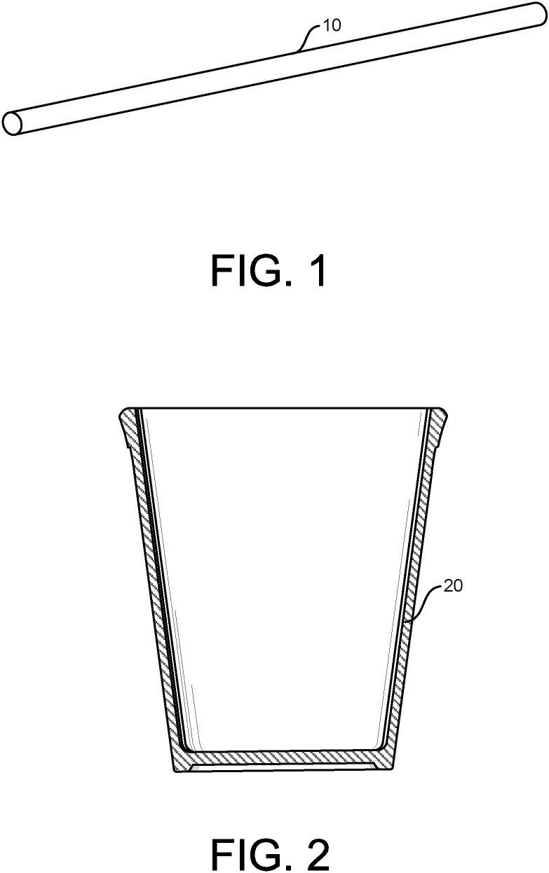

For instance, referring to FIG. 1, a drinking straw 10 is shown that can be made in accordance with the present disclosure. In the past, drinking straws were conventionally made from petroleum-based polymers, such as polypropylene. The cellulose acetate polymer composition of the present disclosure, however, can be formulated so as to match the physical properties of polypropylene. Thus, drinking straws 10 can be produced in accordance with the present disclosure and be completely biodegradable.

Referring to FIG. 2, a cup or beverage holder 20 is shown that can also be made in accordance with the present disclosure. The cup 20 can be made, for instance, using injection molding or through any suitable thermoforming process. As shown in FIG. 7, a lid 22 for the cup 20 can also be made from the polymer composition of the present disclosure. The lid can include a pour spout 24 for dispensing a beverage from the cup 20. In addition to lids for beverage holders, the polymer composition of the present disclosure can be used to make lids for all different types of containers, including food containers, package containers, storage containers and the like.

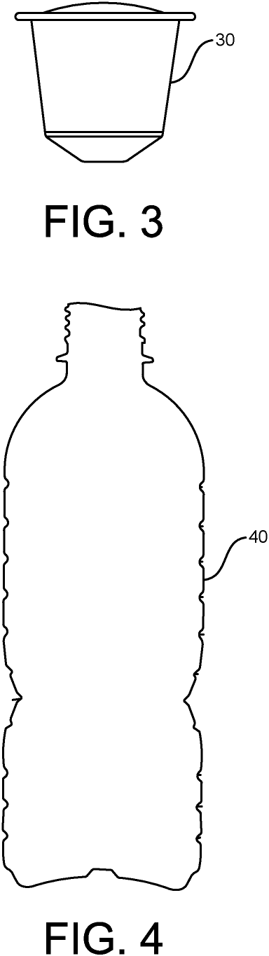

In still another embodiment, the polymer composition can be used to produce a hot beverage pod 30 as shown in FIG. 3. In addition to the beverage pod 30, the polymer composition can also be used to produce a plastic bottle 40 as shown in FIG. 4, which can serve as a water bottle or other sport drink container.

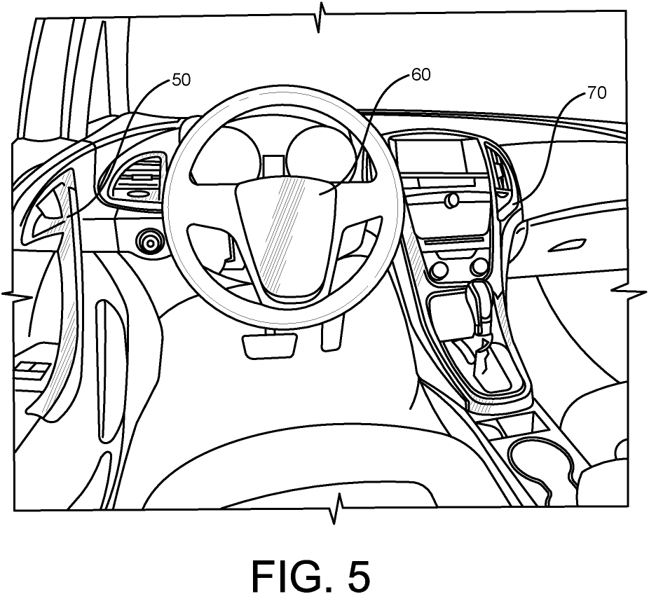

Referring to FIG. 5, an automotive interior is illustrated. The automotive interior includes various automotive parts that may be made in accordance with the present disclosure. The polymer composition, for instance, can be used to produce automotive part 50, which comprises at least a portion of an interior door handle. The polymer composition may also be used to produce a part on the steering column, such as automotive part 60. In general, the polymer composition can be used to mold any suitable decorative trim piece or bezel, such as trim piece 70. In addition, the polymer composition can be used to produce knobs or handles that may be used on the interior of the vehicle.

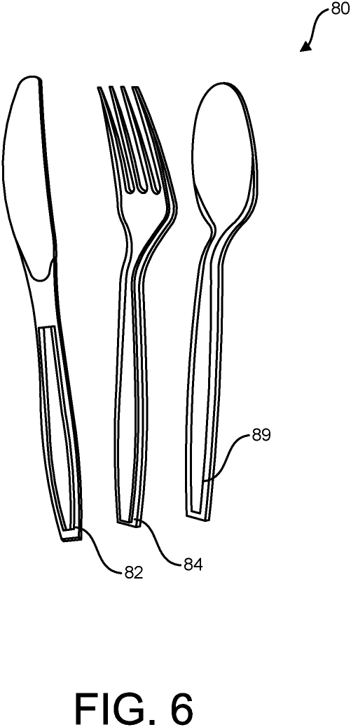

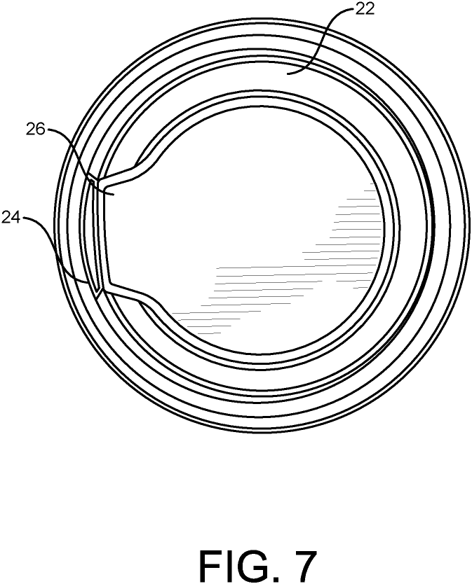

The polymer composition is also well suited to producing cutlery, such as forks, spoons, and knives. For example, referring to FIG. 6, disposable cutlery 80 is shown. The cutlery 80 includes a knife 82, a fork 84, and a spoon 86.

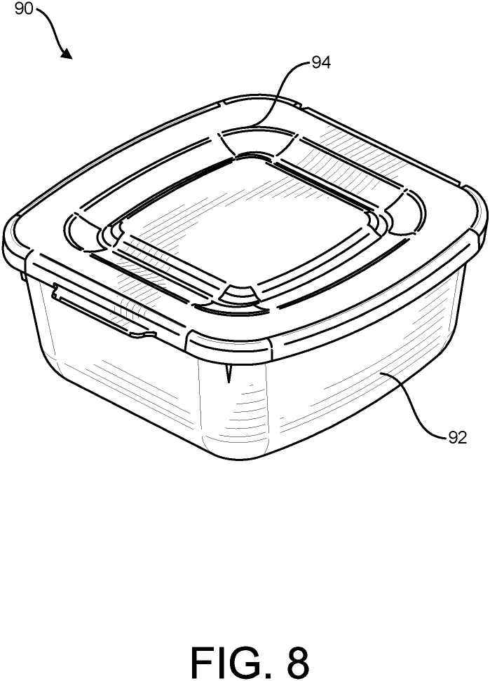

In still another embodiment, the polymer composition can be used to produce a storage container 90 as shown in FIG. 8. The storage container 90 can include a lid 94 that cooperates and engages the rim of a bottom 92. The bottom 92 can define an interior volume for holding items. The container 90 can be used to hold food items or dry goods.

In still other embodiments, the polymer composition can be formulated to produce paper plate liners, eyeglass frames, screwdriver handles, or any other suitable part.

The cellulose ester composition of the present disclosure is also particularly well-suited for use in producing medical devices including all different types of medical instruments. The cellulose ester composition, for instance, is well suited to replacing other polymers used in the past, such as polycarbonate polymers. Not only is the cellulose ester composition of the present disclosure biodegradable, but the composition has a unique “warm touch” feel when handled. Thus, the composition is particularly well suited for constructing housings for medical devices. When held or grasped, for instance, the polymer composition retains heat and makes the device or instrument feel warmer than devices made from other materials in the past. The sensation is particularly soothing and comforting to those in need of medical assistance and can also provide benefits to medical providers. In one aspect, the cellulose ester composition used to produce housings for medical devices includes a cellulose ester polymer combined with a plasticizer (e.g. triacetin) and optionally another bio-based polymer. In addition, the composition can contain one or more coloring agents.

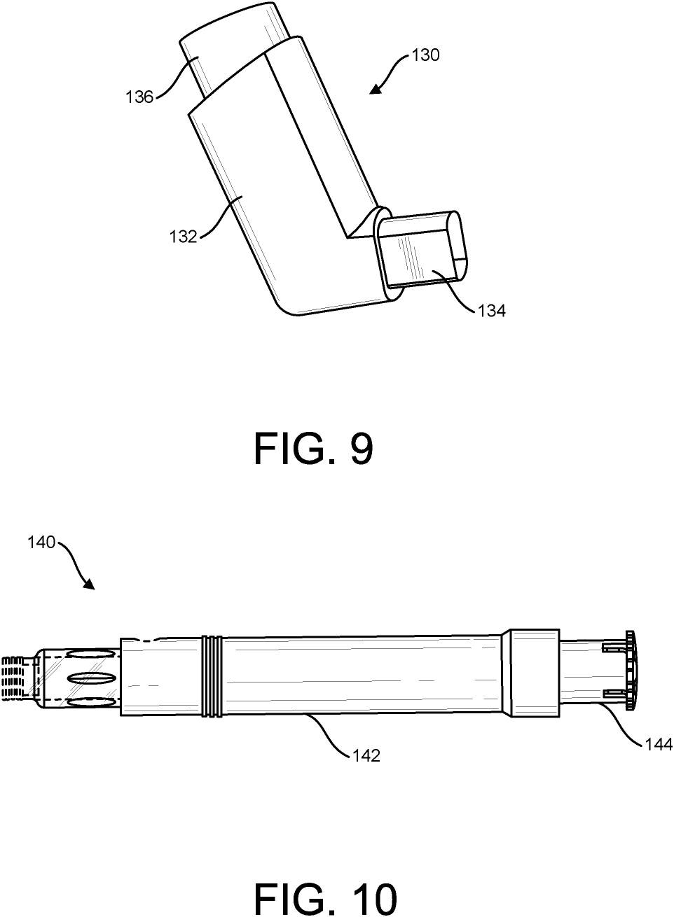

Referring to FIG. 9, for instance, an inhaler 130 is shown that may be made from the cellulose ester polymer composition. The inhaler 130 includes a housing 132 attached to a mouthpiece 134. In operative association with the housing 132 is a plunger 136 for receiving a canister containing a composition to be inhaled. The composition may comprise a spray or a powder.

During use, the inhaler 130 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 132, the mouthpiece 134 and the plunger 136 can all be made from a polymer composition as described above.

Referring to FIG. 10, another medical product that may be made in accordance with the present disclosure is shown. In FIG. 10, a medical injector 140 is illustrated. The medical injector 140 includes a housing 142 in operative association with a plunger 144. The housing 142 may slide relative to the plunger 144. The medical injector 140 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 142 and/or the plunger 144 can be made from a polymer composition as described above.

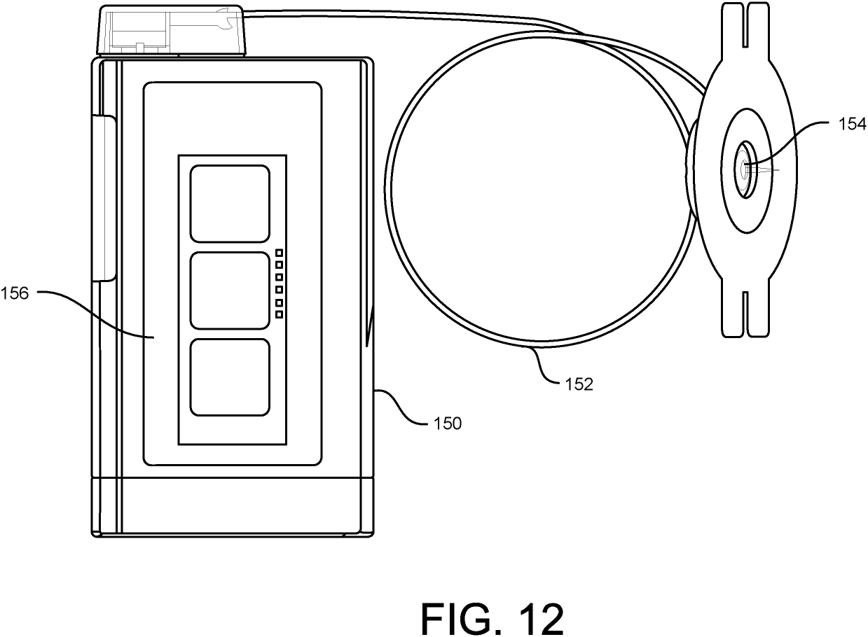

The medical injector 140 as shown in FIG. 10 can be used to inject insulin. Referring to FIG. 12, an insulin pump device 150 is illustrated that can include a housing 156 also made from the polymer composition of the present disclosure. The insulin pump device 150 can include a pump in fluid communication with tubing 152 and a needle 154 for subcutaneously injecting insulin into a patient.

The polymer composition of the present disclosure can also be used in all different types of laparoscopic devices. Laparoscopic surgery refers to surgical procedures that are performed through an existing opening in the body or through one or multiple small incisions. Laparoscopic devices include different types of laparoscopes, needle drivers, trocars, bowel graspers, rhinolaryngoscopes and the like.

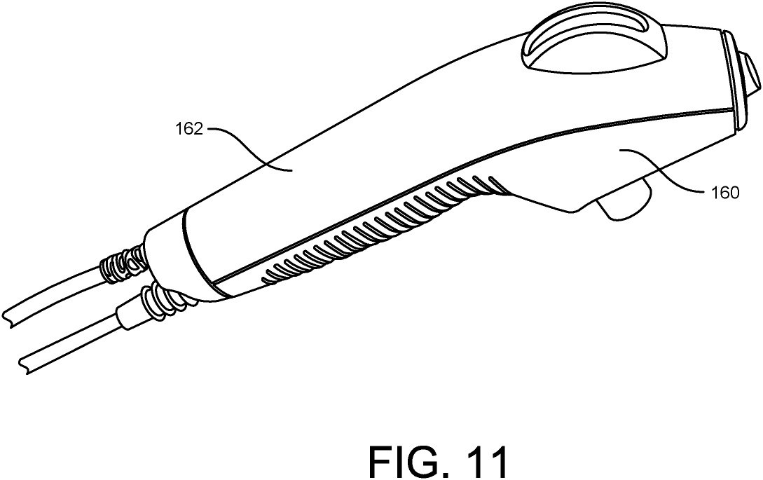

Referring to FIG. 11, for example, a rhinolaryngoscope 160 made in accordance with the present disclosure is shown. The rhinolaryngoscope 160 includes small, flexible plastic tubes with fiberoptics for viewing airways. The rhinolaryngoscope can be attached to a television camera to provide a permanent record of an examination. The rhinolaryngoscope 160 includes a housing 162 made from the polymer composition of the present disclosure. The rhinolaryngoscope 160 is for examining the nose and throat. With a rhinolaryngoscope, a doctor can examine most of the inside of the nose, the eustachian tube openings, the adenoids, the throat, and the vocal cords.

Molded articles can be made from the polymer composition of the present disclosure using any suitable method or technique. For example, fibers and films can be formed through extrusion. Cast films can also be formed. In other embodiments, the molded articles can be formed through injection molding or blow molding.

In one embodiment, the polymer composition can be first formed into a film and then thermoformed into an article.

During thermoforming, the film substrate is heated and then manipulated into a desired three-dimensional shape. The substrate can be formed over a male mold or a female mold. There are two main types of thermoforming typically referred to as vacuum forming or pressure forming. Both types of thermoforming use heat and pressure in order to form a film substrate into its final shape. During vacuum forming, a film substrate is placed over a mold and vacuum is used to manipulate it into a three-dimensional article. During pressure forming, pressure optionally in combination with vacuum forces are used to mold the film substrate into a shape.

The use of thermoforming to produce three-dimensional articles has various advantages. For instance, thermoforming allows for the production of all different types of shapes with fast turnaround times. Modifications to designs can also occur quickly and efficiently. Thermoforming can also be cost effective and can produce articles having an aesthetic appearance.

The temperature and pressure to which the foam substrate is subjected during the thermoforming process can vary depending upon various different factors including the thickness of the foam substrate and the type of product being formed. In general, thermoforming may be conducted at a temperature of from about 75° to about 120°, such as from about 75° to about 100°. Higher temperatures, however, can also be used. As described above, the foam substrate is also subjected to pressure and/or suction forces that press the foam substrate against a mold for conforming the foam substrate to the shape of the mold. Once molded, the three-dimensional article can be trimmed and/or polished as desired.

The present disclosure may be better understood with reference to the following example.

### Example No. 1

The following example demonstrates some of the advantages and benefits of the present disclosure.

Various cellulose ester polymer compositions were formulated, formed into ISO test plaques and tested for various properties. Samples were produced containing hydrotalcite and compared with a sample not containing an odor control agent. The following samples were produced.

| Sample # | 1 | 2 | 3 |
|---|---|---|---|
| Citric acid | 0.02 | 0.02 | 0.02 |
| Bis (2,4-dicumylphenyl) pentaerythritol diphosphite | 0.095 | 0.095 | 0.095 |
| Cellulose acetate dry flake | 72.885 | 72.635 | 72.385 |
| Triacetin | 27 | 27 | 27 |
| Hydrotalcite | | 0.25 | 0.5 |
| total % | 100 | 100 | 100 |

The following tests were conducted on the compositions (using the most recent edition of the standardized test):

| | |
|---|---|
| Tensile Stress at break and Tensile Modulus, 50 mm/min (MPa) | ISO 527 |
| Tensile Strain at break, 50 mm/min (%) | ISO 527 |
| Flexural Modulus and Flexural Strength, 23° C. (MPa) | ISO 178 |
| Charpy Notched Impact strength, 23° C. (kJ/m^2) | ISO 179 |
| DTUL @ 1.8 or 0.45 MPa (°C) | ASTM D648 |

Color measurements were also taken. As used herein, CIELab color values L*, a*, and b* are measured according to the color space specified by the International Commission on Illumination. The L*a*b* colourimetric system was standardized in 1976 by Commission Internationale de I′Eclairage (CIE).

| Sample # | 1 | 2 | 3 |
|---|---|---|---|
| Density via Helium | 1.2928 | 1.2908 | 1.244 |
| MI 210C 2.16 kg | 8.048 | 3.574 | 2.989 |
| Pellet color L | 58.89 | 60.42 | 60.21 |
| Pellet color a | -0.58 | -0.46 | -0.12 |
| Pellet color b | 10.73 | 11.51 | 12.04 |
| Volatiles wt% | 0.8459 | 0.454 | 0.2952 |
| Tensile Modulus | | | |
| Mpa | 1870 | 2101 | 2128 |
| Yield Stress Mpa | 30.18 | 34.53 | 35.63 |
| Yield Strain % | 2.9 | 3.22 | 3.38 |
| Break Stress Mpa | 28.2 | 33.68 | 34.68 |
| Break Strain % | 12.36 | 11.17 | 9.94 |
| Flex Modulus Mpa | 2168 | 2453 | 2495 |
| Flex Strength Mpa | 44.34 | 50.15 | 51.84 |
| Charpy Unnotched KJ/m2 | 63.3 | 44 | 43.5 |
| Charpy Notched KJ/m2 | 11.8 | 11 | 10.2 |
| DTUL @0.45 MPa | 60.5 | 64.8 | 68.2 |
| Acetic Acid mg/KG w/ Triacetin in standard | 518 | 192 | 208 |
| Acetic Acid mg/KG w/o Triacetin in standard | 638 | 237 | 256 |

As shown above, the samples made according to the present disclosure had better properties. The samples displayed lower acid levels at the same or better strength characteristics.

The samples were also tested for transparency, haze and clarity at a thickness of 4 mm. The following results were obtained.

| | | | |
|---|---|---|---|
| Sample # | 1 | 2 | 3 |
| Description | Unfilled | 0.25% Hydrotalcite | 0.5% Hydrotalcite |
| Thickness | 4 mm | 4 mm | 4 mm |
| Transparency (%) | 87.9 | 82.4 | 76.0 |
| Haze (%) | 65.37 | 34.60 | 50.23 |
| Clarity (%) | 54.5 | 80.5 | 80.3 |

As shown above, the optical properties of the samples made according to the present disclosure were dramatically better than Sample No. 1.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a cellulose ester polymer;
a plasticizer; and
an odor control agent, the odor control agent comprising a mineral filler in the form of particles dispersed throughout the polymer composition, the odor control agent being present in the polymer composition in an amount from about 0.05% by weight to about 3% by weight, the polymer composition displaying a haze of less than about 40% measured according to ASTM D1003.

2. A polymer composition as defined in claim 1, wherein the polymer composition displays a haze of less than about 15%, at a thickness of 3 mm according to ASTM D1003.

3. A polymer composition as defined in claim 1, wherein the polymer composition displays a light transmission at a wavelength of from 380 nm to 780 nm of greater than about 70% at a thickness of 3 mm.

4. A polymer composition as defined in claim 1, wherein the odor control agent comprises a magnesium compound, a zinc compound, an aluminum compound, or mixtures thereof.

5. A polymer composition as defined in claim 1, wherein the odor control agent comprises a hydrotalcite.

6. A polymer composition as defined in claim 1, wherein the odor control agent is present in the polymer composition in an amount from about 0.1% by weight to about 1% by weight.

7. A polymer composition as defined in claim 1, wherein the cellulose ester polymer is present in the polymer composition in an amount from about 15% to about 85% by weight.

8. A polymer composition as defined in claim 1, wherein the plasticizer is present in the polymer composition in an amount from about 8% to about 40% by weight.

9. A polymer composition as defined in claim 1, wherein the cellulose ester polymer comprises cellulose acetate having a degree of substitution of from about 1.3 to about 2.9.

10. A polymer composition as defined in claim 1, wherein the plasticizer comprises polyethylene glycol, monoacetin, diacetin, triacetin, triethyl citrate, acetyl triethyl citrate or mixtures thereof.

11. A polymer composition as defined in claim 1, wherein the cellulose acetate consists essentially of cellulose diacetate.

12. An article made from the polymer composition as defined in claim 1.

13. An article as defined in claim 12, wherein the article is a beverage holder, a drinking straw, a hot beverage pod, a fork, a knife, a spoon, packaging, a container, a lid, or an interior automotive part.

14. An article as defined in claim 12, wherein the article has been formed through injection molding or extrusion.

15. An article as defined in claim 12, wherein the article comprises an extruded film.

16. A polymer composition comprising:
a polysaccharide ester;
a plasticizer; and
an odor control agent;
wherein the composition has light transmission greater than about 10 percent measured according to ASTM D1003 and a reduced free carboxylic acid content by about 20 percent.

17. A polymer composition as defined in claim 16, wherein the polymer composition displays a light transmission at a wavelength of from 380 nm to 780 nm of greater than about 20% at a thickness of 3 mm.

18. A polymer composition as defined in claim 16, wherein the odor control agent comprises a magnesium compound, a zinc compound, an aluminum compound, or mixtures thereof and wherein the odor control agent is present in the polymer composition in an amount from about 0.05% by weight to about 3% by weight, and wherein the polysaccharide ester is present in the polymer composition in an amount from about 55% to about 85% by weight, and wherein the plasticizer is present in the polymer composition in an amount from about 10% to about 40% by weight, and wherein the polysaccharide ester polymer comprises cellulose acetate.

19. A polymer composition as defined in claim 16, wherein the plasticizer comprises polyethylene glycol, monoacetin, diacetin, triacetin, triethyl citrate, acetyl triethyl citrate or mixtures thereof.

20. An article made from the polymer composition as defined in claim 16, wherein the article is a beverage holder, a drinking straw, a hot beverage pod, a fork, a knife, a spoon, packaging, a container, a lid, or an interior automotive part.
